(19) United States
(12) Patent Application Publication
(10) Pub. No.: US 2024/0254296 A1
(43) Pub. Date: Aug. 1, 2024

(54) PROCESS FOR PRODUCING ANION EXCHANGERS

(71) Applicant: LANXESS Deutschland GmbH, Cologne (DE)

(72) Inventor: Bernd Koop, Cologne (DE)

(73) Assignee: LANXESS Deutschland GmbH, Cologne (DE)

(21) Appl. No.: 18/560,438

(22) PCT Filed: May 16, 2022
(86) PCT No.: PCT/EP2022/063207

§ 371 Date: Nov. 13, 2023

(30) Foreign Application Priority Data
May 17, 2021 (EP) 21174063.4

(51) Int. Cl. C08J 5/22; C08F 4/10; C08F 212/10

(52) U.S. Cl. CPC C08J 5/2237; C08F 4/10; C08F 212/10

(57) ABSTRACT

The present invention relates to a novel method for producing anion exchangers

The present invention relates to a novel process for producing anion exchangers.

A process for producing anion exchangers known from EP-B 1000660 for example is the reaction of chloromethylated, vinylaromatic polymer with ammonia to produce anion exchangers having primary amine groups. A disadvantage of this process, however, is the low yield achieved in the reaction. The chloromethylated, vinylaromatic polymers are therefore usually reacted with primary, secondary or tertiary amines and used as anion exchangers.

Reacting chloromethylated, vinylaromatic polymer with ammonia, primary or secondary amines, affords exchangers having a lower exchange capacity than theoretically expected, since the amine reacts several times with the chloromethylated groups and produces undesirable secondary crosslinking.

DD-A 79152 describes the reaction of a chloromethylated, vinylaromatic polymer with hexamethylenetetramine to give an aminomethylated, vinylaromatic polymer. The disadvantage here is that only a small proportion of the nitrogen is bound to the polymer.

Another process for producing anion exchangers having primary amine functionalities is known from EP-B 1078688. Here, the vinylaromatic polymer is amidomethylated with a bis(phthalimidomethyl) ether and then hydrolyzed. The bis(phthalimidomethyl) ether is usually first produced from phthalimide and formaldehyde in the presence of sulfuric acid and then the vinylaromatic polymer is added. After the amidomethylation, the anion exchanger having primary amine functionalities is produced from the amidomethylated polymer by hydrolysis with acids or bases. This anion exchanger can be further converted into strong, weak and mixed basic anion exchangers having secondary, tertiary and quaternary amine functionalities by functionalization with alkylating agents.

This process also has disadvantages, since unstable intermediates are produced which complicate the reaction procedure, and by-products are also produced which have to be processed or disposed of in a laborious or expensive manner.

Processes for producing anion exchangers are known from JP-A 51005392 and JP-A 51034295 in which the acylaminomethylated, vinylaromatic polymer is produced by reacting the vinylaromatic polymer with organic nitriles and formaldehyde in a Friedel-Crafts-analogous, catalyzed alkylation on the phenyl ring and the anion exchanger is obtained by hydrolysis.

In this process also, unstable intermediates are formed which make the reaction procedure more difficult and which produce large amounts of solvents of ecological concern.

There was therefore still a need for a process with which the disadvantages of the prior art can be overcome, and by which anion exchangers can be produced in high yield.

Surprisingly, it has now been found that chloromethylated, vinylaromatic polymers can be converted into anion exchangers in good yield by reaction with a nitrile in the presence of a metal-containing catalyst and subsequent hydrolysis.

The present invention therefore provides a process for producing anion exchangers of formula (I),

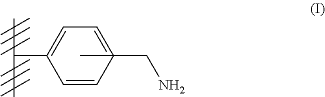

wherein [symbol] is a vinylaromatic polymer radical,
characterized in that
in a step a) chloromethylated, vinylaromatic polymer of formula (II),

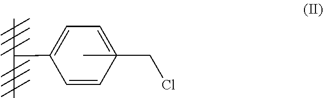

wherein [symbol] is as defined above, is reacted with at least one nitrile of formula (III)

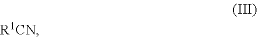

wherein R¹=straight-chain, cyclic or branched C₁-C₈-alkyl, phenyl or benzyl and the phenyl and benzyl may be substituted by at least one straight-chain, cyclic or branched C₁-C₈-alkyl radical,
in the presence of a metal-containing catalyst to afford an amidomethylated, vinylaromatic polymer of formula (IV)

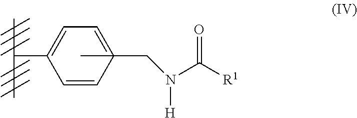

and R¹ is as defined above and the amidomethylated, vinylaromatic polymer of formula (IV) is hydrolyzed in a step b) by reaction with an acid or base to afford the anion exchanger of formula (I).

The scope of the invention encompasses all definitions of radicals, parameters and elucidations above and detailed hereinafter, in general terms or mentioned within preferred ranges, together with one another, i.e. including any combination between the respective ranges and preferred ranges.

R¹ is preferably a straight-chain or branched C₁-C₄-alkyl. Particularly preferably, R¹=methyl, ethyl, n-propyl or isopropyl. Especially preferably, R¹=methyl.

If R¹=phenyl or benzyl, then said phenyl or benzyl is preferably unsubstituted. If the phenyl and benzyl is substituted, then they are preferably substituted by a straight-chain, cyclic or branched C₁-C₈-alkyl radical.

In the context of the invention, C₁-C₈-alkyl is a straight-chain, cyclic or branched alkyl radical having 1 to 8 (C₁-C₈) carbon atoms, even more preferably having 1 to 4 (C₁-C₄) carbon atoms. Preferably, C₁-C₈-alkyl is methyl, ethyl, n-propyl, isopropyl, n-, i-, s- or t-butyl, cyclopropyl, cyclobutyl, cyclopentyl, n-hexyl, cyclohexyl, n-pentyl, 1-methylbutyl, 2-methylbutyl, 3-methylbutyl. Particularly preferably, C₁-C₈-alkyl or C₁-C₄-alkyl is ethyl, methyl, n-propyl or isopropyl.

The chloromethylated, vinylaromatic polymers of formula (II) are preferably copolymers of at least one monovinylaromatic monomer selected from the group comprising styrene, vinyltoluene, ethylstyrene, α-methylstyrene, chlorostyrene or chloromethylstyrene and mixtures of at least one of these monomers with at least one polyvinylaromatic compound (crosslinkers) selected from the group comprising divinylbenzene, divinyltoluene, trivinylbenzene, triallyl isocyanurate, divinylnaphthalene and/or trivinylnaphthalene or mixtures of these polyvinylaromatic compounds.

The employed chloromethylated, vinylaromatic polymer of formula (II) is particularly preferably a styrene copolymer, yet more preferably a styrene-divinylbenzene copolymer. A styrene-divinylbenzene copolymer is a copolymer crosslinked using divinylbenzene. The chloromethylated, vinylaromatic polymer of formula (II) preferably has a spherical shape.

In the chloromethylated, vinylaromatic polymer in formula (II) a —CH₂—Cl is bonded to a phenyl radical.

The chloromethylated, vinylaromatic polymers of formula (II) employed according to the invention preferably have a macroporous structure.

The terms microporous or gel-form/macroporous have already been described in detail in the literature, for example, in Seidl, Malinsky, Dusek, Heitz, Adv. Polymer Sci., 1967, Vol. 5, pp. 113 to 213. The possible methods of measurement for macroporosity, for example mercury porosimetry and BET determination, are likewise described in said document. The pores of the macroporous polymers of the chloromethylated, vinylaromatic polymers of formula (II) employed according to the invention generally and preferably have an average diameter of 20 nm to 100 nm. The pore diameter is preferably determined using mercury porosimetry.

The chloromethylated, vinylaromatic polymers of formula (II) employed according to the invention preferably have a monodisperse distribution.

In the present application, monodisperse materials are those in which at least 90% by volume or 90% by mass of the particles have a diameter within the interval of ±10% of the most common diameter.

For example, in the case of a material having a most common diameter of 0.5 mm, at least 90% by volume or 90% by mass is within a size interval between 0.45 mm and 0.55 mm; in the case of a material having a most common diameter of 0.7 mm, at least 90% by volume or 90% by mass is within a size interval between 0.77 mm and 0.63 mm.

The chloromethylated, vinylaromatic polymer of formula (II) preferably has a diameter of 200 to 1500 μm.

The chloromethylated, vinylaromatic polymer of formula (II) preferably has a spherical shape.

The chloromethylated, vinylaromatic polymer of formula (II) preferably comprises 88 mol % to 98 mol % of monovinylaromatic monomers based on the total amount of substance of the polymer. The chloromethylated, vinylaromatic polymer of formula (II) preferably comprises 2 mol % to 12 mol % of polyvinylaromatic monomers based on the total amount of substance of the polymer.

The anion exchanger of formula (I) preferably has a diameter of 200 to 1500 μm.

The anion exchanger of formula (I) preferably has a macroporous structure.

The anion exchanger of formula (I) preferably has a monodisperse distribution.

The anion exchanger of formula (I) preferably comprises 88 mol % to 98 mol % of monovinylaromatic monomers based on the total amount of substance of the polymer.

The anion exchanger of formula (I) preferably comprises 2 mol % to 12 mol % of polyvinylaromatic monomers based on the total amount of substance of the polymer.

The chloromethylated, vinylaromatic polymers of formula (II) employed in step a) are preferably produced in a step 1a) by
1a) reacting monomer droplets composed of at least one monovinylaromatic compound and at least one polyvinylaromatic compound and at least one initiator and
1b) chloromethylating the polymer from step 1a).

Step 1a) employs at least one monovinylaromatic compound and at least one polyvinylaromatic compound. However, it is also possible to employ mixtures of two or more monovinylaromatic compounds and mixtures of two or more polyvinylaromatic compounds.

In the context of the present invention, the monovinylaromatic compounds employed in step 1a) are preferably styrene, vinyltoluene, ethylstyrene, α-methylstyrene, chlorostyrene or chloromethylstyrene.

The monovinylaromatic compounds are preferably used in amounts >50% by weight, based on the monomer or mixture thereof with other monomers, particularly preferably between 55% by weight and 70% by weight based on the monomer or mixture thereof with other monomers.

It is especially preferable to employ styrene or mixtures of styrene with the aforementioned monomers, preferably with ethylstyrene.

Preferred polyvinylaromatic compounds in the context of the present invention for step 1a) are divinylbenzene, divinyltoluene, trivinylbenzene, triallyl isocyanurate, divinylnaphthalene or trivinylnaphthalene, particularly preferably divinylbenzene.

The polyvinylaromatic compounds are preferably used in amounts of 1%-20% by weight, particularly preferably 2%-12% by weight, especially preferably 4%-10% by weight, based on the monomer or the mixture thereof with further monomers. The type of polyvinylaromatic compounds (crosslinkers) is selected having regard to the later use of the polymer. If divinylbenzene is used, commercial grades of divinylbenzene containing not only the isomers of divinylbenzene but also ethylvinylbenzene are sufficient.

Macroporous, vinylaromatic polymers are preferably formed by addition of inert materials, preferably at least one porogen, to the monomer mixture in the course of polymerization to produce a macroporous structure in the polymer. Especially preferred porogens are hexane, octane, isooctane, isododecane, pentamethylheptane, methyl ethyl ketone, butanol or octanol and isomers thereof. Especially suitable organic substances are those which dissolve in the monomer but are poor solvents or swellants for the polymer (precipitants for polymers), for example aliphatic hydrocarbons (Farbenfabriken Bayer DBP 1045102, 1957; DBP 1113570, 1957).

U.S. Pat. No. 4,382,124 employs the alcohols having 4 to 10 carbon atoms likewise preferably employable in the context of the present invention as porogens for producing macroporous vinylaromatic polymers based on styrene/divinylbenzene. It also provides an overview of the production methods of macroporous vinylaromatic polymers.

Porogens are preferably employed in an amount of 25% by weight to 45% by weight based on the amount of the organic phase.

It is preferable when at least one porogen is added in step 1a).

The vinylaromatic polymers produced according to step 1a) may be produced in heterodisperse or monodisperse form.

The production of heterodisperse vinylaromatic polymers is accomplished by general processes known to those skilled in the art, for example by suspension polymerization.

It is preferable when monodisperse, vinylaromatic polymers are produced in step 1a).

In a preferred embodiment of the present invention step 1a) employs microencapsulated monomer droplets in the production of monodisperse, vinylaromatic polymers.

Suitable materials for the microencapsulation of the monomer droplets are those known for use as complex coacervates, especially polyesters, natural and synthetic polyamides, polyurethanes or polyureas.

A natural polyamide used is preferably gelatin. This is employed especially as a coacervate and complex coacervate. In the context of the invention, gelatin-containing complex coacervates are particularly understood to mean combinations of gelatin with synthetic polyelectrolytes. Suitable synthetic polyelectrolytes are copolymers incorporating units of, for example, maleic acid, acrylic acid, methacrylic acid, acrylamide and methacrylamide. Particular preference is given to using acrylic acid and acrylamide. Gelatin-containing capsules may be hardened with customary hardeners, for example formaldehyde or glutardialdehyde. The encapsulation of monomer droplets with gelatin, gelatin-containing coacervates and gelatin-containing complex coacervates is described in detail in EP-A 0 046 535. The methods for encapsulation with synthetic polymers are known. Preference is given to interfacial condensation in which a reactive component (especially an isocyanate or an acid chloride) dissolved in the monomer droplet is reacted with a second reactive component (especially an amine) dissolved in the aqueous phase.

The heterodisperse or optionally microencapsulated, monodisperse monomer droplets contain at least one initiator or mixtures of initiators (initiator combination) to trigger the polymerization. Initiators preferred for the process according to the invention are peroxy compounds, especially preferably dibenzoyl peroxide, dilauroyl peroxide, bis(p-chlorobenzoyl) peroxide, dicyclohexyl peroxydicarbonate, tert-butyl peroctoate, tert-butyl peroxy-2-ethylhexanoate, 2,5-bis(2-ethylhexanoylperoxy)-2,5-dimethylhexane or tert-amylperoxy-2-ethylhexane, and also azo compounds, such as 2,2′-azobis(isobutyronitrile) or 2,2′-azobis(2-methylisobutyronitrile).

The initiators are preferably employed in amounts of 0.05% to 2.5% by weight, particularly preferably 0.1% to 1.5% by weight, based on the monomer mixture.

The optionally monodisperse, microencapsulated monomer droplet may optionally also contain up to 30% by weight (based on the monomer) of crosslinked or uncrosslinked polymer. Preferred polymers derive from the aforementioned monomers, particularly preferably from styrene.

In a further preferred embodiment the aqueous phase in the production of monodisperse, vinylaromatic polymers in step 1a) may contain a dissolved polymerization inhibitor. Useful inhibitors in this case include both inorganic and organic substances. Preferred inorganic inhibitors are nitrogen compounds, especially preferably hydroxylamine, hydrazine, sodium nitrite and potassium nitrite, salts of phosphorous acid such as sodium hydrogen phosphite, and sulfur-containing compounds such as sodium dithionite, sodium thiosulfate, sodium sulfite, sodium bisulfite, sodium thiocyanate and ammonium thiocyanate. Examples of organic inhibitors are phenolic compounds such as hydroquinone, hydroquinone monomethyl ether, resorcinol, catechol, tert-butylcatechol, pyrogallol and condensation products of phenols with aldehydes. Further preferred organic inhibitors are nitrogen-containing compounds. Especially preferred are hydroxylamine derivatives such as N,N-diethylhydroxylamine, N-isopropylhydroxylamine and sulfonated or carboxylated N-alkylhydroxylamine or N,N-dialkylhydroxylamine derivatives, hydrazine derivatives such as N,N-hydrazinodiacetic acid, nitroso compounds such as N-nitrosophenylhydroxylamine, N-nitrosophenylhydroxylamine ammonium salt or N-nitrosophenylhydroxylamine aluminum salt. The concentration of the inhibitor is 5-1000 ppm (based on the aqueous phase), preferably 10-500 ppm, particularly preferably 10-250 ppm.

The polymerization of the optionally microencapsulated, monodisperse monomer droplets to give the monodisperse, vinylaromatic polymer is preferably carried out in the presence of one or more protective colloids in the aqueous phase. Suitable protective colloids are natural or synthetic water-soluble polymers, preferably gelatin, starch, polyvinyl alcohol, polyvinylpyrrolidone, polyacrylic acid, polymethacrylic acid or copolymers of (meth)acrylic acid and (meth)acrylic esters. Preference is further given to cellulose derivatives, especially cellulose esters and cellulose ethers, such as carboxymethyl cellulose, methyl hydroxyethyl cellulose, methyl hydroxypropyl cellulose and hydroxyethyl cellulose. Gelatin is especially preferred. The use amount of the protective colloids is generally 0.05% to 1% by weight based on the aqueous phase, preferably 0.05% to 0.5% by weight.

In an alternative preferred embodiment the polymerization to give the monodisperse, vinylaromatic polymer may be performed in the presence of a buffer system. Preference is given to buffer systems which adjust the pH of the aqueous phase at the start of the polymerization to a value between 14 and 6, preferably between 12 and 8. Under these conditions, protective colloids having carboxylic acid groups are wholly or partly present as salts. This has a favorable effect on the action of the protective colloids. Particularly well-suited buffer systems contain phosphate or borate salts. In the context of the invention, the terms “phosphate” and “borate” also encompass the condensation products of the ortho forms of corresponding acids and salts. The concentration of the phosphate or borate in the aqueous phase is preferably 0.5-500 mmol/l, particularly preferably 2.5-100 mmol/l.

The stirrer speed in the polymerization to give the monodisperse, vinylaromatic polymer is less critical and, in contrast to conventional polymerization, has no effect on particle size. Low stirrer speeds sufficient to keep the suspended monomer droplets in suspension and to promote the removal of the heat of polymerization are employed. Various stirrer types can be used for this task. Particularly suitable stirrers are axial-action gate stirrers.

The volume ratio of encapsulated monomer droplets to aqueous phase is preferably 1:0.75 to 1:20, particularly preferably 1:1 to 1:6.

The polymerization temperature to give the monodisperse, vinylaromatic polymer is determined by the decomposition temperature of the employed initiator. It is preferably between 50 to 180° C., particularly preferably between 55 and 130° C. The polymerization preferably lasts 0.5 to about 20 hours. It has proved useful to employ a temperature program in which the polymerization is commenced at low temperature, preferably 60° C., and the reaction temperature is raised as the polymerization conversion progresses. In this way, for example, the requirement for reliable running of the reaction and high polymerization conversion can be fulfilled very efficiently. After the polymerization the monodisperse, vinylaromatic polymer is isolated by customary methods, for example by filtration or decanting, and optionally washed.

The production of the monodisperse, vinylaromatic polymers using the jetting principle or the seed-feed principle is known from the prior art and described, for example, in U.S. Pat. No. 4,444,961, EP-A 0 046 535, U.S. Pat. No. 4,419,245 or WO 93/12167.

Production of the monodisperse, vinylaromatic polymers is preferably carried out with the aid of the jetting principle or the seed-feed principle.

Step 1a) preferably comprises producing a macroporous, monodisperse, vinylaromatic polymer.

In step 1b) the vinylaromatic polymer is converted into the chloromethylated, vinylaromatic polymer of formula (II),

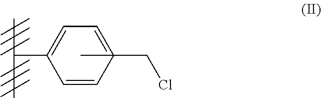

wherein [symbol] is a vinylaromatic polymer,
by chloromethylation.

Step 1b) preferably employs chloromethyl methyl ether as the chloromethylating agent. The chloromethyl methyl ether may be used in unpurified form and may contain methylal and methanol for example as secondary components. Step 1b) preferably employs the chloromethyl methyl ether in excess. The chloromethylation reaction is catalyzed by addition of a Lewis acid. Suitable Lewis acids are preferably iron(III) chloride, zinc chloride, tin(IV) chloride and aluminum chloride. The reaction temperature in step 1b) is preferably in the range from 40 to 80° C. In a preferred embodiment step 1b) is performed at standard pressure and at a temperature of 50 to 60° C. During the reaction the volatile constituents, such as preferably hydrochloric acid, methanol, methylal, formaldehyde and some chloromethyl methyl ether, are removed, preferably by evaporation. To remove the remaining chloromethyl methyl ether and to purify the chloromethylate the reaction mixture is preferably washed with a mixture of methylal, methanol and water.

Step 1b) preferably produces a macroporous, chloromethylated vinylaromatic polymer of formula (II).

The chloromethylated, vinylaromatic polymer of formula (II) produced in step 1b) is preferably employed as reactant in step a).

Step a) preferably employs acetonitrile, propionitrile, butyronitrile, isovalerylnitrile, benzonitrile, o-methylbenzonitrile, m-methylbenzonitrile, p-methylbenzonitrile and phenylacetonitrile as nitriles of formula (III). It is very particularly preferable when the employed nitrile of formula (III) is acetonitrile.

Step a) preferably employs inorganic or organic metal(II), metal(III) or metal(IV) salts or mixtures of such salts as metal-containing catalysts. The employed metal-containing catalysts are preferably iron(II) salts, iron(III) salts, zinc(II) salts, tin(II) salts or tin(IV) salts and mixtures of these compounds. The employed metal-containing catalysts are particularly preferably iron(II) chloride, iron(II) bromide, iron(II) nitrate, iron(II) sulfate, iron(II) perchlorate, iron(II) phosphate, iron(II) acetate, iron(III) chloride, iron(III) bromide, iron(III) nitrate, iron(III) sulfate, iron(III) perchlorate, iron(III) phosphate, iron(III) acetate, zinc(II) chloride, zinc(II) bromide, zinc(II) nitrate, zinc(II) sulfate, zinc(II) perchlorate, zinc(II) phosphate, zinc(II) acetate, tin(II) chloride, tin(II) bromide, tin(II) nitrate, tin(II) sulfate, tin(II) perchlorate, tin(II) phosphate, tin(II) acetate, tin(IV) chloride, tin(IV) bromide, tin(IV) nitrate, tin(IV) sulfate, tin(IV) perchlorate, tin(IV) phosphate or tin(IV) acetate or mixtures of these salts. The employed metal-containing catalysts are particularly preferably zinc(II) perchlorate, zinc(II) chloride and iron(III) chloride and their hydrates. The employed metal-containing catalyst is very particularly preferably zinc(II) perchlorate, in particular the hexahydrate.

Step a) preferably employs the nitriles of formula (III) in a ratio of 100:1 to 1:1, particularly preferably in a ratio of 50:1 to 1:1 based on the amount of substance of chlorine in the employed chloromethylated, vinylaromatic polymer of formula (II).

Step a) preferably employs the metal-containing catalyst in a ratio of 1:100 to 1:1, particularly preferably in a ratio of 1:50 to 1:0.5 based on the amount of substance of chlorine in the employed chloromethylated, vinylaromatic polymer of formula (II).

Step a) of the process according to the invention may be performed in the presence or absence of polar or non-polar, inert solvents. Step a) of the process according to the invention is preferably performed in the absence of solvents. Preferably employed polar, inert solvents are water or alcohols, preferably methanol, ethanol, propanol or butanol or mixtures of these polar, inert solvents.

Preferably employed nonpolar, inert solvents are halogenated, aliphatic or aromatic hydrocarbons, such as preferably dichloromethane, dichloroethane, dibromomethane, trichloromethane, tetrachlorocarbon or benzotrifluoride or mixtures of these solvents.

In a preferred embodiment of the invention the chloromethylated, vinylaromatic polymers of formula (II) are initially charged and then contacted with the nitrile of formula (III) and the metal-containing catalyst. The mixture is subsequently heated to the reaction temperature.

The reaction temperature in step a) is preferably between 60° C. and 140° C., preferably between 70° C. and 110° C.

In step a) the pressure is preferably in a range from 0.8 to 3 bar.

The reaction is preferably completed within 1 to 24 hours, preferably within 4 to 12 hours.

Workup is carried out by processes known to those skilled in the art for workup of corresponding process products, for example by neutralization and filtration of the resulting amidomethylated, vinylaromatic polymers of formula (IV).

The hydrolysis of the amidomethyl group and thus the revealing of the aminomethyl group is carried out in step b) by treatment with at least one base or at least one acid. The bases employed in step b) for the hydrolysis of the amidomethylated, vinylaromatic polymers of formula (IV) are preferably selected from alkali metal hydroxides, alkaline earth metal hydroxides, ammonia or hydrazine. The acids employed in step b) are preferably selected from nitric acid, phosphoric acid, sulfuric acid, hydrochloric acid, sulfurous acid or nitrous acid. Step b) preferably employs at least one base for the hydrolysis of the amidomethyl group and thus for the revealing of the aminomethyl group.

The hydrolysis of the amidomethyl group in step b) is preferably carried out at a temperature of 80° C. to 250° C., preferably of 80° C. to 190° C., if an acid is used for the hydrolysis. The concentration of the acid in step b) is preferably in the range from 5% by weight to 90% by weight, particularly preferably between 10% by weight and 70% by weight based on the aqueous phase.

It is particularly preferable when the hydrolysis of the amidomethyl group and thus the revealing of the aminomethyl group in step b) is carried out by treating the amidomethylated, vinylaromatic polymer of formula (IV) with aqueous or alcoholic solutions of an alkali metal hydroxide, such as preferably sodium hydroxide or potassium hydroxide, at temperatures of between 80° C. and 250° C., preferably of 120° C. to 190° C. The concentration of the aqueous sodium hydroxide solution is preferably 20% by weight to 60% by weight based on the aqueous phase.

The hydrolysis of the amidomethyl group to the aminomethyl group in step b) is preferably carried out with an excess of acid and/or base based on the amount of employed amidomethyl groups.

The anion exchanger of formula (I) formed in step b) is generally washed to neutrality with demineralized water. However, it is also employable without aftertreatment.

The anion exchangers of formula (I) may be further functionalized by known processes by reaction with alkylating agents in secondary, tertiary and quaternary amine-containing anion exchangers and chelating resins.

Anion exchangers may be produced in large amounts by the process according to the invention.

### Determination of the Amount of Basic Groups

100 ml of the aminomethylated polymer is shaken down in the tamping volumeter and subsequently washed into a glass column with demineralized water. 1000 ml of 2% by weight sodium hydroxide solution is filtered through over 1 hour and 40 minutes. Demineralized water is then filtered through until 100 ml of eluate with added phenolphthalein has a consumption of 0.1 N (0.1 normal) hydrochloric acid of at most 0.05 ml.

50 ml of this resin is admixed in a beaker with 50 ml of demineralized water and 100 ml of 1 N hydrochloric acid. The suspension is stirred for 30 minutes and then transferred into a glass column. The liquid is drained off. A further 100 ml of 1 N hydrochloric acid is filtered through the resin over 20 minutes. 200 ml of methanol is then filtered through. All eluates are collected and combined and titrated with 1 N sodium hydroxide solution against methyl orange.

The amount of aminomethyl groups in 1 liter of aminomethylated resin is calculated according to the following formula: (200−V)·20=mol of aminomethyl groups per liter of resin, where V is the volume of the 1 N sodium hydroxide solution consumed in the titration.

The molar amount of the basic groups corresponds to the molar amount of the aminomethyl groups in the resin.

### Determination of the Amount of Chloromethylated Groups

The amount of chloromethylated groups is calculated by determining the chlorine content of the dried resin by elemental analysis.

### EXAMPLES

### Example 1

### 1a) Production of the Monodisperse, Macroporous Polymer Based on Styrene, Divinylbenzene and Ethylstyrene

A 101 glass reactor is initially charged with 3000 g of demineralized water and a solution of 10 g of gelatin, 16 g of disodium hydrogenphosphate dodecahydrate and 0.73 g of resorcinol in 320 g of deionized water is added and mixed in. The temperature of the mixture is adjusted to 25° C. Subsequently, with stirring, a mixture of 3200 g of microencapsulated monomer droplets having a narrow particle size distribution, composed of 3.1% by weight of divinylbenzene and 0.6% by weight of ethylstyrene (used in the form of a commercial isomer mixture of divinylbenzene and ethylstyrene with 80% divinylbenzene), 0.4% by weight of dibenzoyl peroxide, 58.4% by weight of styrene and 37.5% by weight of isododecane (technical isomer mixture having a high proportion of pentamethylheptane) is added, the microcapsule consisting of a formaldehyde-hardened complex coacervate composed of gelatin and a copolymer of acrylamide and acrylic acid, and 3200 g of aqueous phase having a pH of 12 are added.

The mixture is stirred and polymerized to completion by increasing the temperature in accordance with a temperature program commencing at 25° C. and ending at 95° C. The mixture is cooled, washed through a 32 μm sieve and then dried at 80° C. under reduced pressure.

This affords 1893 g of a polymer having a monodisperse particle size distribution. The average diameter of the pores in the polymer is 42 nm.

1b) Chloromethylation of the Monodisperse, Macroporous Polymer from 1a)

1120 ml of a mixture of monochlorodimethyl ether, methylal and iron(III) chloride (14.8 g/l) were initially charged in a 2 liter sulfonation flask and then 240 g of bead polymer from 1a) were added. The mixture was heated to 50° C. and stirred in the range 50-55° C. under reflux for 6 h. Hydrochloric acid and low-boiling organics were evaporated/removed by distillation over the reaction time. The reaction suspension was then washed intensively in succession with 1200 ml of methanol, 2400 ml of methylal, 3 times with 1200 ml of methanol and finally with deionized water. This afforded 590 ml of water-moist, monodisperse, macroporous, chloromethylated polymer having a chlorine content of 21.9% by weight.

### Example 2

Reaction of the Chloromethylated, Vinylaromatic Polymer from Example 1b) with Acetonitrile and Iron(III) Chloride to Afford the Amidomethylated, Vinylaromatic Polymer of Formula (IV)

21 g of water-moist chloromethylate (0.13 mol of Cl) from example 1b) are initially charged in a round-bottomed flask and washed twice with 100 ml of acetonitrile each time. 150 ml of acetonitrile (2.8 mol) and 35.1 g of iron(III) chloride hexahydrate (0.13 mol) are then added to the beads. The mixture is heated under reflux for 6 hours, then cooled and admixed with 150 ml of 7% by weight aqueous hydrochloric acid at room temperature. The beads are separated from the reaction solution by filtration and washed three times with 200 ml of demineralized water each time.

Yield: 64 ml of resin

Nitrogen content: 5.5% by weight (dried resin)

### Example 3

Reaction of the Chloromethylated, Vinylaromatic Polymer from Example 1b) with Acetonitrile and Zinc(II) Chloride to Afford the Amidomethylated, Vinylaromatic Polymer of Formula (IV)

21 g of water-moist chloromethylate (0.13 mol of Cl) from example 1b) are initially charged in a round-bottomed flask and washed twice with 100 ml of acetonitrile each time. 150 ml of acetonitrile (2.8 mol) and 8.9 g of zinc(II) chloride (0.07 mol) are then added to the beads. The mixture is heated under reflux for 6 hours, then cooled and admixed with 150 ml of 7% by weight aqueous hydrochloric acid at room temperature. The beads are separated from the reaction solution by filtration and washed three times with 200 ml of demineralized water each time.

Yield: 61 ml of resin

Nitrogen content: 4.6% by weight (dried resin)

### Example 4

Reaction of the Chloromethylated, Vinylaromatic Polymer from Example 1b) with Acetonitrile and Zinc(II) Perchlorate Hexahydrate to Afford the Anion Exchanger of Formula (I)

a) 165.8 g of water-moist chloromethylate (1.085 mol of Cl) from example 1b) are initially charged in a round-bottomed flask and washed twice with 500 ml of acetonitrile each time. 1200 ml of acetonitrile (22.4 mol) and 201.1 g of zinc(II) perchlorate hexahydrate (0.54 mol) are then added to the beads. The mixture is heated under reflux for 20 hours, then cooled and admixed with 1200 ml of 7% by weight aqueous hydrochloric acid at room temperature. The beads are separated from the reaction solution by filtration and washed three times with 200 ml of demineralized water each time.

Yield: 548 ml of resin

Nitrogen content: 7.0% by weight (dried resin)

b) Hydrolysis of the amidomethylated, vinylaromatic polymer from example 4a)

103.2 g of 50% by weight aqueous sodium hydroxide solution and 232 ml of demineralized water are added to 250 ml of amidomethylated polymer from example 4a) at room temperature. The suspension is heated to 180° C. over 2 hours and stirred at this temperature for 8 hours. The obtained polymer is washed with demineralized water.

Yield of aminomethylated polymer: 188 ml

Determination of the amount of basic groups: 2.17 mol/liter of resin

### Example 5

Reaction of the Chloromethylated Bead Polymer from Example 1b) with Benzonitrile and Zinc(II) Chloride to Afford the Amidomethylated, Vinylaromatic Polymer of Formula (IV)

17 g of water-moist chloromethylate (0.11 mol of Cl) from example 1b) are initially charged in a round-bottomed flask and washed twice with 50 ml of benzonitrile each time. 120 ml of benzonitrile (1.15 mol) and 7.2 g of zinc(II) chloride (0.05 mol) are then added to the beads. The mixture is heated to 80° C. for 6 hours, then cooled and admixed with 120 ml of 7% by weight aqueous hydrochloric acid at room temperature. The beads are separated from the reaction solution by filtration, washed three times with 200 ml of acetone each time and three times with 200 ml of deionized water each time.

Yield: 50 ml of resin

Nitrogen content: 3.5% by weight (dried resin)

1. A process for producing anion exchangers of formula (I), 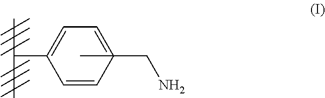
wherein [symbol] is a vinylaromatic polymer radical,
characterized in that
in a step a) chloromethylated, vinylaromatic polymer of formula (II), 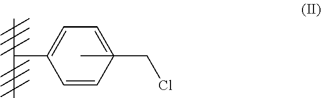
wherein [symbol] is as defined above, is reacted with at least one nitrile of formula (III) 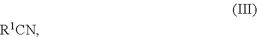
wherein R¹=straight-chain, cyclic or branched C₁-C₈-alkyl, phenyl or benzyl and the phenyl and benzyl may be substituted by at least one straight-chain, cyclic or branched C₁-C₈-alkyl radical,
in the presence of a metal-containing catalyst to afford an amidomethylated, vinylaromatic polymer of formula (IV) 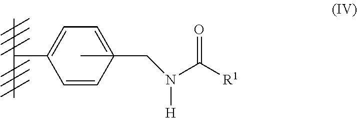
and R¹ is as defined above and
the amidomethylated, vinylaromatic polymer of formula (IV) is hydrolyzed in a step b) by reaction with an acid or base to afford the anion exchanger of formula (I).

2. The process as claimed in claim 1, characterized in that R¹=straight-chain or branched C₁-C₄-alkyl in formula (III).

3. The process as claimed in claim 1, characterized in that the employed nitrile of formula (III) is acetonitrile.

4. The process as claimed in claim 1, characterized in that the employed metal-containing catalysts are inorganic or organic metal(II), metal(III) or metal(IV) salts or mixtures of such salts.

5. The process as claimed in claim 1, characterized in that the employed metal-containing catalysts are iron(II) salts, iron(III) salts, zinc(II) salts, tin(II) salts or tin(IV) salts and mixtures of these compounds.

6. The process as claimed in claim 1, characterized in that the employed metal-containing catalysts are zinc(II) perchlorate, zinc(II) chloride and iron(III) chloride and their hydrates or mixtures of these compounds.

7. The process as claimed in claim 1, characterized in that the employed metal-containing catalyst is zinc(II) perchlorate.

8. The process as claimed in claim 1, characterized in that the employed chloromethylated, vinylaromatic polymer of formula (II) is a chloromethylated styrene copolymer.

9. The process as claimed in claim 8, characterized in that the employed chloromethylated, vinylaromatic polymer is a chloromethylated styrene-divinylbenzene copolymer of formula (II).

10. The process as claimed in claim 1, characterized in that step a) employs the nitriles of formula (III) in a ratio of 100:1 to 1:1 based on the amount of substance of chlorine in the employed chloromethylated, vinylaromatic polymer of formula (II).

11. The process as claimed in claim 1, characterized in that step a) employs metal-containing catalysts in a ratio of 1:100 to 1:0.5 based on the amount of substance of employed chloromethylated, vinylaromatic polymer of formula (II).

12. The process as claimed in claim 1, characterized in that the chloromethylated, vinylaromatic polymer of formula (II) contains 88 mol % to 98 mol % of monovinylaromatic monomers and 2 mol % to 12 mol % of polyvinylaromatic monomers based on the total amount of substance of the polymer.

13. The process as claimed in claim 1, characterized in that the chloromethylated, vinylaromatic polymer of formula (II) employed in step a) is produced by reacting monomer droplets of at least one monovinylaromatic compound and at least one polyvinylaromatic compound and at least one initiator in a step 1a) and by chloromethylation in a step 1b).

14. The process as claimed in claim 1, characterized in that the hydrolysis in step b) is performed at a temperature of 80° C. to 250° C.

15. The process as claimed in claim 1, characterized in that step a) employs a chloromethylated, macroporous, vinylaromatic polymer of formula (II).
